(19) United States
(12) Patent Application Publication
(10) Pub. No.: US 2004/0026043 A1
(43) Pub. Date: Feb. 12, 2004

(54) Core forming apparatus

(76) Inventor: Andrew Michael Wirth, Driffield (GB)

Correspondence Address: Fay, Sharpe, Fagan,, Minnich & McKee, LLP, 7th Floor, 1100 Superior Avenue, Cleveland, OH, 44114-2518, US

(21) Appl. No.: 10/637,236

(22) Filed: Aug. 8, 2003

(30) Foreign Application Priority Data
Aug. 8, 2002 (GB) GB-0218349.9

(51) Int. Cl. B31C 3/00

(52) U.S. Cl. 156/446; 493/304; 493/306

(57) ABSTRACT

A web winding apparatus comprises one or more wind mandrels (3) each supported for rotation about its central axis, and a core forming apparatus (1) for forming a core on the or on each mandrel (3) in turn from a continuous web (5) of gummed material. The core forming apparatus (1) comprises means (6) for presenting the free end of the continuous web (5) to a winding mandrel (3), means for rotating the winding mandrel about its central axis to cause the web (5) to wrap around the winding mandrel (3), means (10) for applying water to the web (10) to activate the adhesive and thereby bond together the layers of paper wrapped on the winding mandrel (3) and means for cutting the continuous web from the core when the core has reached a predetermined diameter.

The present invention relates generally to a roll winder comprising one or more winding mandrels for winding a continuous web into rolls. More specifically, the present invention relates to a core forming apparatus for use with a roll winder whereby a tubular supporting core is formed on the or each winding mandrel prior to winding a roll thereon.

Turret winders are known for winding a continuous web of paper or other material into small rolls which may be conveniently handled by the ultimate user. The web of material may be output directly from a web making machine to the turret winder, but more usually the web coming from the web making machine is formed into large rolls which may be conveniently stored. These large primary roll are then rewound into smaller secondary rolls. Depending on the width of the web, it may be wound into a single roll, or it may be split into narrower widths which are then wound simultaneously into several rolls.

Generally a turret winder consists of a frame having a turret mounted thereon which supports a plurality of circumferentially spaced winding mandrels or spindles. The turret is indexable to bring each of the mandrels in turn to a web winding station. Here the free end of the continuous web is presented to the mandrel, which is then rotated about its axis to wind the web into a roll of a predetermined diameter. Once the roll has been wound, the web is cut and the turret is indexed to move the roll supporting mandrel to an unload station, where the roll is removed, and to bring the next mandrel to the web winding station. In this way continuous production of rolls is achieved.

The web may be wound directly onto the mandrel or onto a tubular core positioned on the mandrel. The present invention is concerned with the latter case. With conventional winders the cores are preformed, usually from cardboard, and must be preloaded one at time onto the mandrels as they become free. For this purpose the turret winder must be provided with a further core loading station to which each mandrel in turn is indexed to receive a core. The core may be loaded onto the mandrel manually or automatically using a core loader.

The provision of an automatic or manual core loader increases costs and operator input. Furthermore, the addition of a core loading station, to which each mandrel in turn must be indexed, increases the cycle time of the turret winder. A further disadvantage which arises from the use of pre-formed cores is that care must be taken to ensure that sufficient cores are always available to complete a given winding operation. This requires a stock of cores to be carried which is space consuming and inconvenient.

It is an object of the present invention to provide a core forming apparatus for use with a roll winder having one or more winding mandrels whereby one or more cores can be formed on the or each winding mandrel prior to winding a roll thereon.

According to the present invention there is provided a core forming apparatus for use in combination with a roll winder having one or more winding mandrels, said core forming apparatus comprising means for presenting the free end of a continuous web of gummed paper to a winding mandrel, means for rotating the winding mandrel to cause the web of gummed paper to wrap around the winding mandrel and means for applying water to the gummed paper to activate the adhesive and thereby bond to the layers of paper wrapped on the winding mandrel.

Preferably, the core forming apparatus is carried on a moveable support and is moveable into and out of engagement with the winding mandrel, or with each winding mandrel in turn. Where the roll winder comprises a plurality of winding mandrels, a core forming station is defined, at which the core forming apparatus is located and to which each winding mandrel in turn is indexed to facilitate the formation of a core thereon

Preferably, the water applying means comprises a moistened pad positioned so that the web of gummed paper passes over it towards the mandrel. Conveniently, a water roller is also provided to bias the web into close contact with the moistened pad.

Preferably, the core forming apparatus further comprises a forming tool which is adapted to close around the winding mandrel to guide the web of gummed paper as it is presented and wrapped around it. Conveniently, the forming tool is mounted on an arm which is pivotable between a disengaged position and an engaged position, and which, in the engaged position, pivots outwardly as the core diameter increases.

Conveniently, the core forming apparatus also comprises a driven nip which presents the free end of the web of gummed paper to the mandrel.

An embodiment of the present invention will now be described by way of example with reference to the accompany drawings, in which:

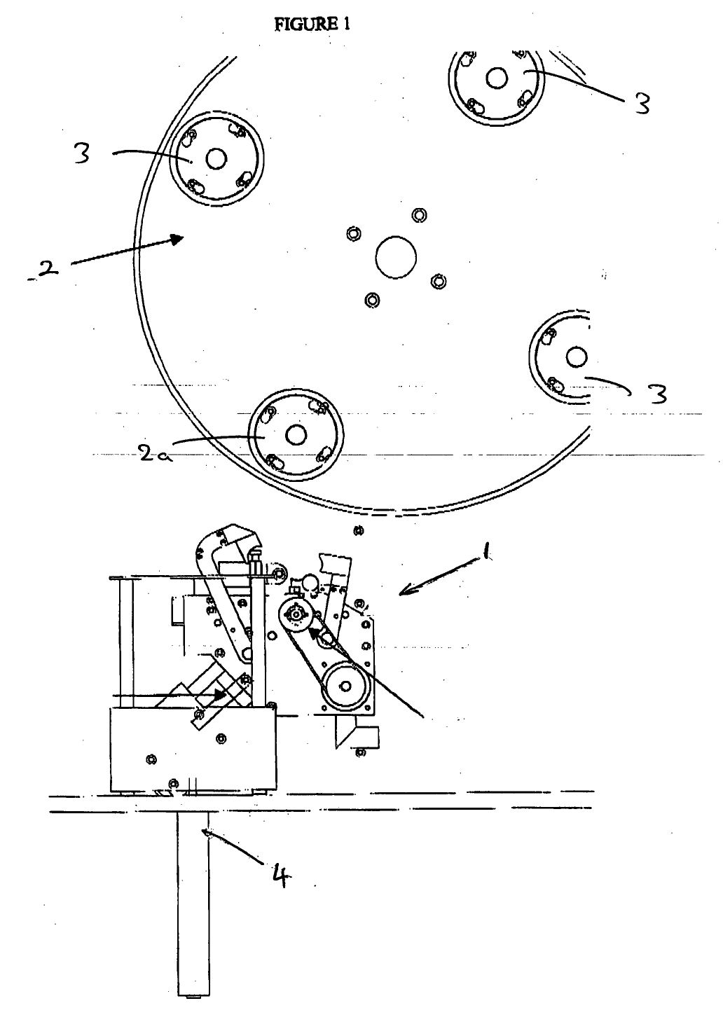

FIG. 1 shows a partial schematic view of a turret winder having a core forming apparatus, the core forming apparatus being retracted from the winding mandrel located at the core winding station;

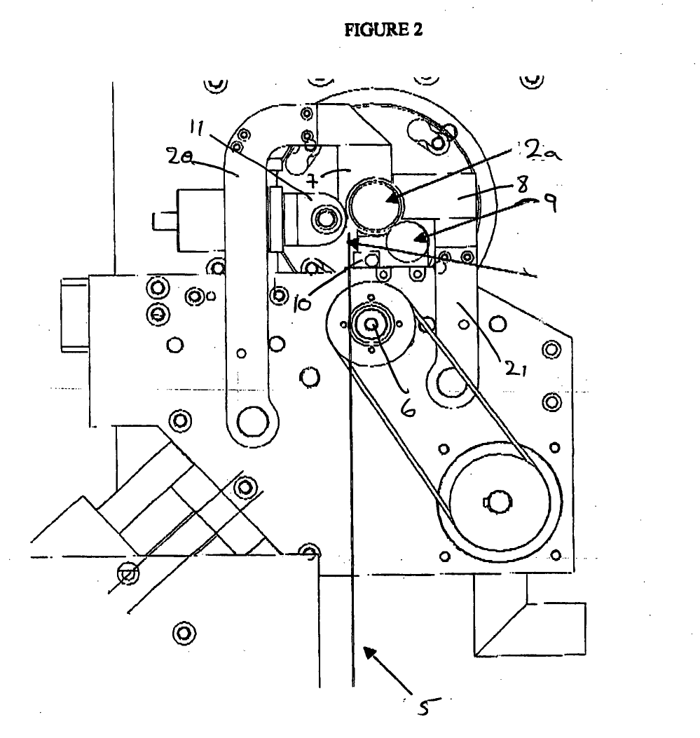

FIG. 2 shows a detailed schematic view of the core forming apparatus in engagement with the roll winding mandrel;

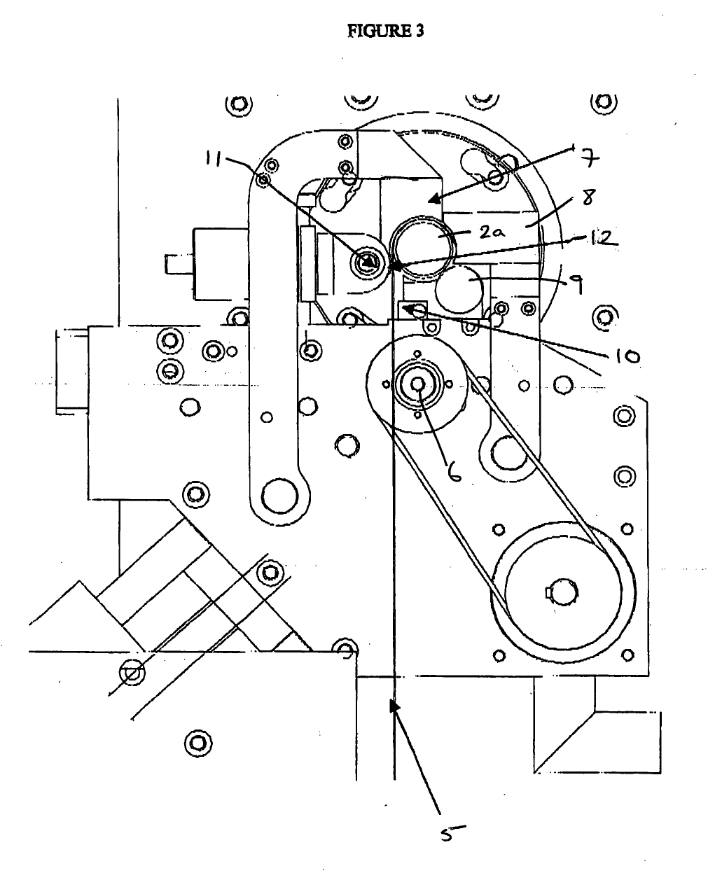

FIG. 3 shows a detailed schematic view of the core forming apparatus in engagement with the winding mandrel after a core has been formed thereon; and

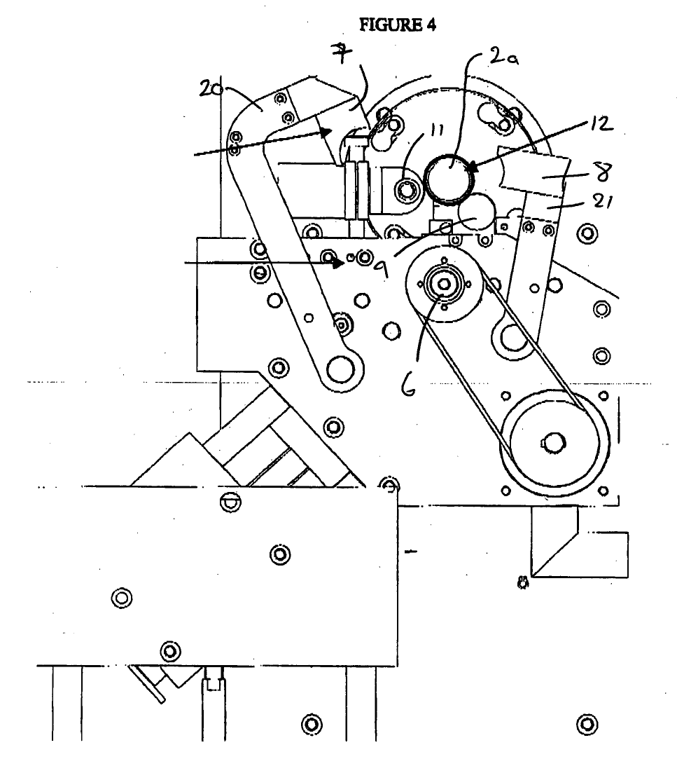

FIG. 4 shows a detailed schematic view of the core forming apparatus after the web of gummed paper forming the core has been cut and the core forming apparatus disengaged from the winding mandrel, immediately prior to retraction thereof.

Referring to FIG. 1 there is shown a core forming apparatus, generally designated 1, positioned adjacent to the turret 2 of a turret winder. The turret carries four roll winding mandrels 3 and is indexable to a number of stations including a core winding station immediately adjacent to the core forming apparatus 1 and presently occupied by the mandrel designated 2a. The core forming apparatus 1 is mounted on a lifting cylinder 4 which allows the apparatus to be raised and lowered relative to the core winding station and the mandrel 2a occupied thereby. As shown in FIG. 1 the core forming apparatus 1 is retracted from the mandrel 2a.

Referring now to FIG. 2 the core forming apparatus is shown in engagement with the mandrel 2a to direct the free end of a continuous web of gummed paper 5 towards and around the mandrel 2a. To this end, the web 5 is directed towards the mandrel 2a by a driven nip 6, and around the mandrel 2a by a pair of forming tools 7 and 8, each of which is carried by a respective pivotable arm 20 and 21. A nip roller 9 on the return side of the mandrel 2a ensures that the free end of the web 5 is directed back towards the web 5 and the outward side of the mandrel 2a. Now, when the mandrel 2a is rotated the web 5 is wrapped around it.

A moistened pad 10 is positioned immediately adjacent to the web 5 as it travels towards the mandrel 2a and a water roller 11 is engageable with the web 5 to bias it into close contact with the pad 10. It is envisaged that the water roller 11 is applied to the web 5 after the first wrap has been formed around the mandrel 2a. Once the gummed paper has been in contact with the moistened pad 10, the adhesive on it is activated and now as successive wraps of gummed paper are formed around the mandrel 2a they bond to each other to form a solid tubular core 12 over the mandrel 2a, as can be seen in FIG. 3. As the thickness of the core 12 increases the forming tools 7 and 8 can be allowed to move outwardly to accommodate the increased diameter. Alternatively the pressure in the lifting cylinder 4 can be partially released to allow the core forming apparatus to move away from the mandrel 2a.

When the core 12 has reached the required diameter, the web 5 is cut and the mandrel 2a is rotated as many times as is necessary to pick up the trailing end around the core 12. Conveniently the trailing end of the web is tamped down by the nip roller 9.

Now, by pivoting the forming tools 7 and 8 away from the mandrel 2a, as shown in FIG. 4, the core forming apparatus 1 is freed from the mandrel 2a and can be lowered on the lifting cylinder back to its starting position. With the core forming apparatus 1 retracted the turret can now be indexed to move the mandrel 2a carrying the wound core 12 to a roll winding station and to bring the next mandrel to the core winding station, whereupon the cycle can be repeated.

It will be appreciated that the core forming apparatus of the present invention is not restricted to being used in combination with turret winders having two or more winding mandrels. It can also be used with roll winders having a single winding mandrel. Here the winding mandrel may be fixed and the core forming apparatus moveable into and out of engagement therewith, or the winding mandrel itself may be moveable into and out of engagement with the core forming apparatus.

1. A web winding apparatus comprising one or more winding mandrels (3) each supported for rotation about its central axis, and a core forming apparatus (1) for forming a core on the or on each mandrel (3) in turn from a continuous web (5) of gummed material, wherein the core forming apparatus (1) comprises means (6) for presenting the free end of the continuous web (5) to the winding mandrel (3), means for rotating the winding mandrel about its central axis to cause the web (5) to wrap around the winding mandrel (3), means (10) for applying water to the web (10) to activate the adhesive and thereby bond together the layers of paper wrapped on the winding mandrel (3) and means for cutting the continuous web from the core when the core has reached a predetermined diameter.

2. Apparatus according to claim 1, characterised in that the core forming apparatus (1) is carried on a moveable support (4) and is moveable into and out of engagement with the winding mandrel (3) or with each winding mandrel (3) in turn.

3. Apparatus according to claim 1 or 2, characterised in that the apparatus comprises a plurality of winding mandrels mounted on a turret assembly and indexing means for indexing the turret assembly about its axis of rotation to bring each winding mandrel in turn into position adjacent the core forming apparatus.

4. Apparatus according to claim 1, 2 or 3, characterised in that the water applying means (10) comprises a moistened pad positioned so that the continuous web (5) of gummed paper passes over it towards the mandrel (5).

5. Apparatus according to claim 4, characterised in that a water roller (11) is provided to bias the continuous web (5) into close contact with the moistened pad (10).

6. Apparatus according to any preceding claim, characterised in that the core forming apparatus further comprises a forming tool (7, 8) which is adapted to close around the winding mandrel (3) to guide the continuous web (5) of gummed paper as it is presented to and wrapped around it.

7. Apparatus according to claim 6, characterised in that the forming tool is mounted on an arm (20, 21) which is pivotable between a disengaged position and engaged position, and which, in the engaged position, pivots outwardly as the core diameter increases.

8. Apparatus according to any preceding claim, characterised in that the core forming apparatus comprises a driven nip which presents the free end of the continuous web of gummed paper to the mandrel.

9. Apparatus according to any preceding claim, comprising means for determining when the core has reached the required diameter.
